(19) United States
(12) Patent Application Publication
(10) Pub. No.: US 2013/0026203 A1
(43) Pub. Date: Jan. 31, 2013

(54) BAND WITH EXPANDABLE POUCH

(71) Applicant: Kimberley J. Overton, Austin, TX (US)

(72) Inventor: Kimberley J. Overton, Austin, TX (US)

(73) Assignee: Overton Enterprises, LLC, Austin, TX (US)

(21) Appl. No.: 13/194,389

(22) Filed: Jul. 29, 2011

(51) Int. Cl. A45C 13/30; B23P 17/04

(52) U.S. Cl. 224/576; 224/222; 29/428

(57) ABSTRACT

Band with expandable pouch. In some embodiments the method includes a pouch formed in a material by making a plurality of folds extending between two ends, and subsequently joining the ends. The pouch may be accessed by pulling back a first portion of the material, pulling back a second portion of the material, inserting an item, and return the portions to their original positions.

### CROSS-REFERENCE TO RELATED APPLICATIONS

None.

### BACKGROUND

1. Field of the Invention

Various embodiments relate to securing small items and more specifically to a band with an expandable pouch configured to retain small items such as on the wrist or ankle.

2. Background

Various devices to carry and conceal small personal items such as keys, currency, and credit cards may be found in athletic and tourist stores. These devices include a pouch or pocket sealable by button, zipper, or hook and loop closures (i.e. VELCRO®). These items are attached to a band or belt that is fastened about the waist, arm, or leg.

However, buttons, zippers, and hook and loop closures may be difficult to operate when exercising or due to sweating. Moreover, buttons, zippers and hook and loop closures may wear out or fail, requiring replacement of the item. Furthermore, buttons, zippers and hook and loop closures may create irritation to the user.

### SUMMARY

A band with expandable pouch, comprising a material extending between a first end and a second end, a first fold extending between the first end and the second end, and a second fold extending between the first end and the second end, wherein the first end and the second end are connected.

A method for manufacturing a band with expandable pouch, comprising obtaining a wearable material, forming a first portion in the material extending between a first end and a second end, forming a second portion in the material extending between a first end and a second end, and joining the first end and the second end to form a loop.

A method for carrying an item, comprising forming a pocket in a material formed in a loop, positioning the loop on a person, and inserting the item into the pocket.

A method for carrying an item in a band with expandable pouch, comprising obtaining a band with expandable pouch, having a substantially circular shape and a pocket wherein the pocket is formed by a second portion overlying a first portion and a first portion overlying a base portion, pulling the second portion such that the first portion is exposed, pulling the first portion such that the base portion is exposed, positioning an item near the base portion and at least partially behind the first portion such that the item is at least partially disposed between the base portion and the first portion, returning the first portion to an original position such that the item is enclosed by the base portion and the first portion, and returning the second portion to an original position, such that the second portion is substantially overlying the first portion.

The foregoing has outlined rather broadly the features and technical advantages of the invention in order that the detailed description that follows may be better understood. Additional features and advantages will be described hereinafter that form the subject of the claims. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments, reference will now be made to the accompanying drawings in which:

FIG. 1 illustrates a band with expandable pouch according to an exemplary embodiment of the present disclosure;

FIG. 2 illustrates a band with expandable pouch according to another exemplary embodiment of the present disclosure;

FIG. 3 illustrates a band with expandable pouch according to another exemplary embodiment of the present disclosure;

FIG. 4 illustrates a band with expandable pouch according to another exemplary embodiment of the present disclosure;

FIG. 5 illustrates a band with expandable pouch according to an exemplary embodiment of the present disclosure worn on the wrist;

FIG. 6 illustrates a band with expandable pouch according to an exemplary embodiment of the present disclosure worn on the wrist;

FIG. 7 illustrates process schematic for storing an item in the band with expandable pouch; and

FIG. 8 illustrates process schematic for manufacturing the accessory according to an exemplary embodiment of the present disclosure

### DETAILED DESCRIPTION

The present disclosure relates to a band with expandable pouch suitable for storing small items on a person. In some embodiments, the band with expandable pouch comprises a single piece of material. The material has a plurality of folds and opposing ends are joined to form a loop suitable for wrapping around a wrist or an ankle. The loop may form a band with folded portions. The folded portions overlap to form a pocket suitable for storing small items on a person. The pocket is accessible without the need for fasteners or closures. The pocket expands by partially displacing the folded portions. The partially displaced folded portions provide security for the small items when returned to original position.

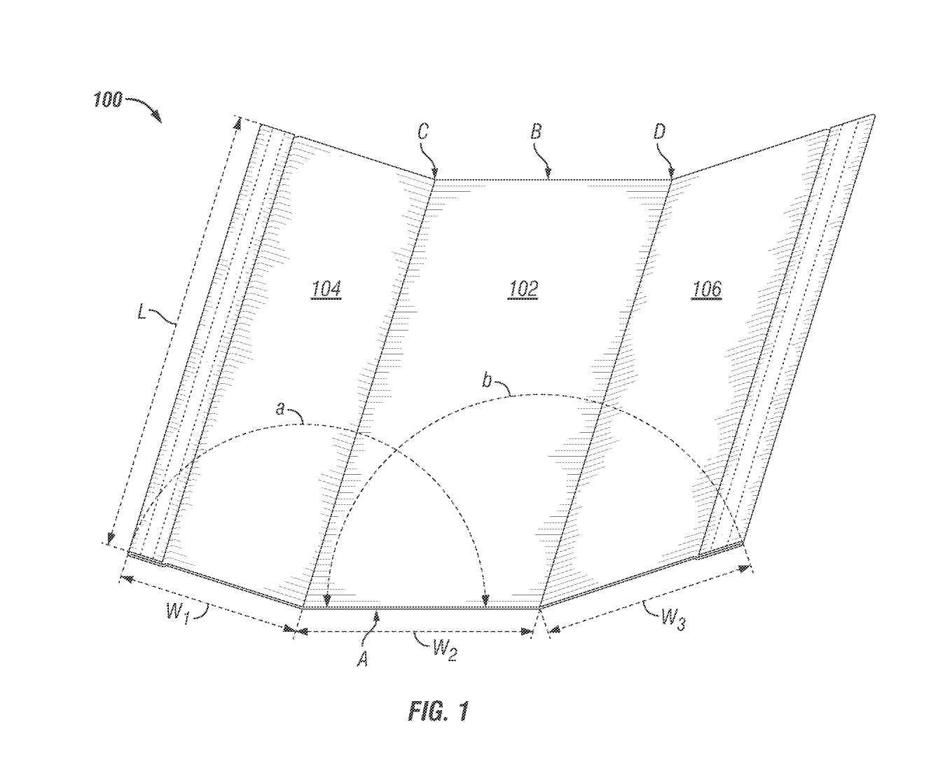

An exemplary embodiment of the present disclosure for a band with expandable pouch 100 may be found in FIG. 1. The band with expandable pouch 100 may be manufactured from any material suitable for wearing on a person or touching a person's skin for extended periods. Non-limiting examples, the band with expandable pouch 100 may comprise cotton, polyamides, polyesters, spandex (i.e. polyurethane/urea copolymer) or other fabrics. The band with expandable pouch 100 may comprise any decorative features, colors, patterns, treatments, or combinations thereof, without limitation. In non-limiting exemplary configurations, band with expandable pouch may comprise a reflective band or alternatively, may be constructed of a reflective material such as SCOTCHLITE™. Alternatively, the band may have additional layers or decorative features attached thereto.

The band with expandable pouch 100 extends from first end A to second end B along length L and normal or perpendicular to width W. The band with expandable pouch 100 has a first fold C and a second fold D, such that three portions are formed. The band with expandable pouch 100 has a base portion 102, a first portion 104, and a second portion 106.

First fold C extends between first end A and second end B and delineates the base portion 102 from the first portion 104. Second fold D extends between first end A and second end B and delineates the base portion 102 from the second portion 106. In some embodiments, first fold C and second fold D are substantially parallel between first end A and second end B.

The distance measured normal to and between first fold C and second fold D is the width of base portion W1. Further, first fold C defines first portion width W2 and second fold D defines second portion width W3. Base portion width W1 is greater than about the first portion width W2 and the second portion width W3. First portion width W2 may be approximately equal to, greater than or less than the second portion width W3.

In exemplary embodiments of the present disclosure illustrated in FIG. 1, first portion 104 is folded (a) along first fold C, such that the first portion 104 contacts the base portion 102. Further, the second portion 106 is folded (b) along second fold D, such that the second portion contacts the first portion 104. The band with expandable pouch 100 folded thusly, has three layers arranged vertically from bottom to top: base portion 102, first portion 104, and second portion 106.

In further embodiments illustrated in FIG. 1, the band with expandable pouch 100 comprises fixing the first portion 104 and the second portion 106 to the base portion at the first end A and the second end B. Fixing the first end A and the second end B may comprise sewing the first portion 104 and the second portion 106 to the base portion 102. Alternatively, fixing the first end A and the second end B may comprise material adhesives, rivets, staples, or other means known to an ordinarily skilled artisan for fixing material.

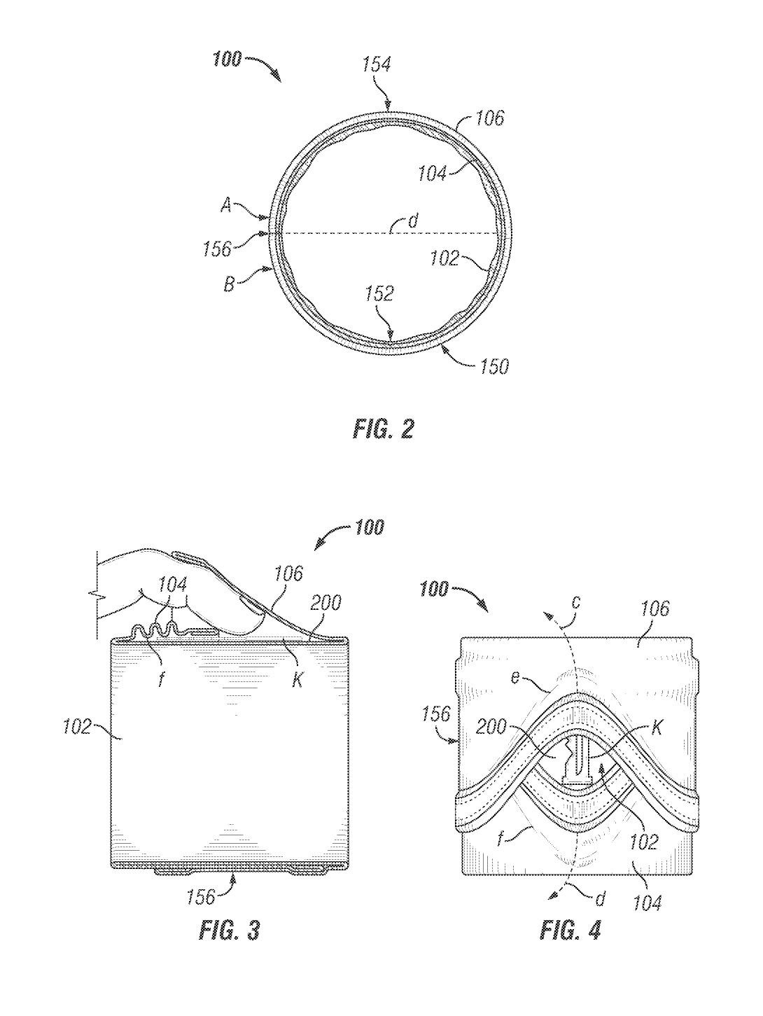

FIG. 2 shows the expandable pouch 100 after first end A and second end B are joined such that a loop 150 is formed. Loop 150 is formed such that base portion 102 forms the inner circumference 152. Loop 150 is formed such that second portion 106 forms the outer circumference 154. In certain embodiments, a portion of outer circumference 154 comprises first portion 104.

The first end A and second B are joined at seam 156. Seam 156 comprises any suitable connection mechanism. Non-limiting exemplary connection mechanisms include sewing, riveting, gluing, adhering, or combinations thereof. In alternate embodiments, it may be understood that seam 156 fixes the first end A and the second end B as previously described. Further, fixing first end A and second end B comprises forming loop 150.

In embodiments of the present disclosure shown in FIGS. 1 and 2, loop 150 has a circumference that is approximately equal to length L of the material. Loop 150 has width that is approximately equal to the base material width W1. Loop 150 has a diameter D that is approximately 3.14 times (i.e. Pi; π) smaller than length L.

In embodiments shown in FIG. 3 and FIG. 4 the second portion 106 is configured to be pulled back (c) to reveal the first portion 104. Subsequently, the first portion 104 is configured be pulled back (d) to reveal or open a pocket 200. The second portion 106 of the band with expandable pouch 100, folds, wrinkles, crumples, or reversibly deforms (e). The first portion 104 of band with expandable pouch 100 folds, wrinkles, crumples, or reversibly deforms (f). The first end A and the second B joined at seam 156 remain substantially in place with respect to the second portion 106 and the first portion 104. Pocket 200 comprises the base portion 102 covered by the first portion 104 and the second portion 106. The base portion 102 forms the base or bottom of the packet 200. Pocket 200 is configured to be secured or closed by reversing pull back (d) of first portion 104 and reversing pull back (c) of second portion.

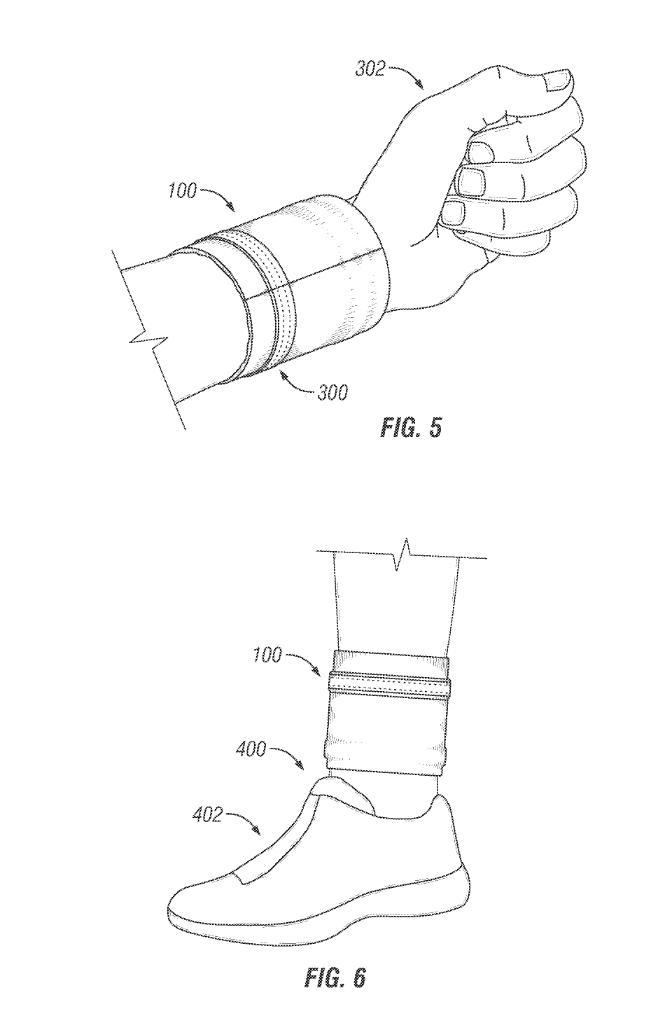

In embodiments shown in FIGS. 5 and 6, the band with expandable pouch 100 is configured for personal carriage on an extremity such as a wrist 300 or ankle 400, respectively. The band with expandable pouch 100 may be constructed of expanding or stretching material for ease of positioning and wearing comfort. Further, the band with expandable pouch may be constructed of expanding or stretching material to improve retention once positioned on the wrist 300 or ankle 400. Without limitation by any particular theory, expanding the band with expandable pouch's 100 diameter D (shown in FIG. 2) allows the band with expandable pouch 100 to slide around a hand 302 or foot 402. Expanding the band with expandable pouch 100 diameter D (shown in FIG. 2) enables automatic adjustment to a variety of wrist 300 or ankle 400 sizes and enables the band with expandable pouch to be “one-size fits all.”

Additionally, expanding or stretching material used for the material describe herein above may improve the security of items placed in the pocket 200. In alternative embodiments, pocket 200 may be secured by a fastener joining second portion 106 to first portion 102. The fastener may be any known to an ordinarily skilled artisan. In further alternative embodiments, seam 156 may comprise a reversible seam, and additional fasteners such as such as a snap, button, hook and loop fastener, or others known to an ordinarily skilled artisan.

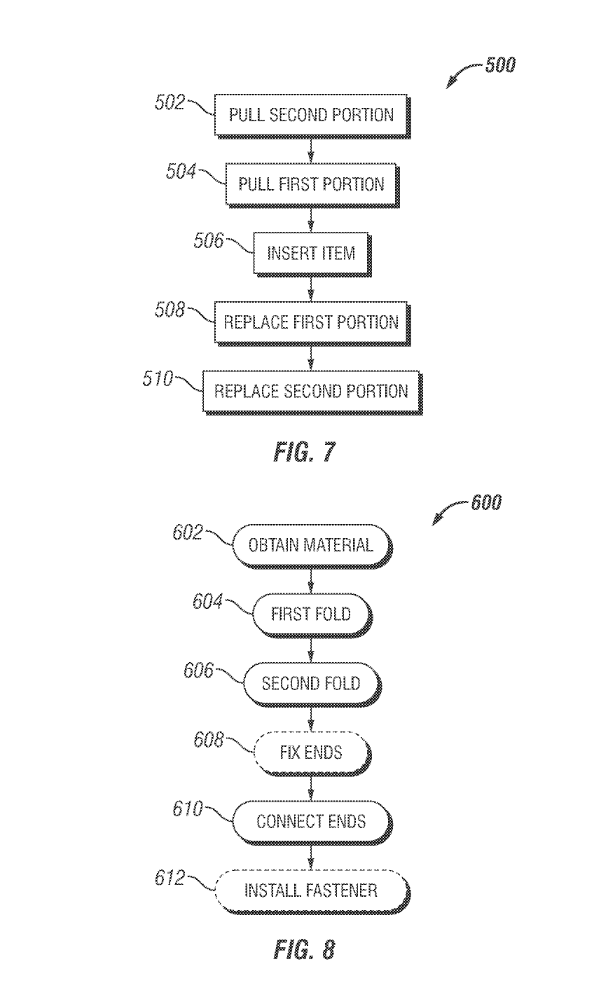

In embodiments of the present disclosure, the band with expandable pouch 100 particularly the pocket 200, are suitable for the retention of items, including without limitation currency, keys, cards, oral tablets, or combinations thereof. Further, the pocket 200 (as shown in FIG. 3) may be accessed as when the band with expandable pouch 100 is being worn on or around an extremity (as shown in FIGS. 5 and 6) according to the process 500 illustrated in FIG. 7. The process 500 for accessing the pocket 200 comprises the steps of pulling 502 the second portion, pulling 504 the first portion, inserting 506 an item to the pocket, replacing 508 the first portion, and replacing 510 the second portion. In reference to FIG. 3 and FIG. 4, the process 500 illustrated in FIG. 7 is associated such that the step of pulling 502 the second portion comprises pulling back (c) second portion 106, and the step of pulling 504 the first portion comprises pulling back (d) first portion 104 of the band with expandable pouch. The step of inserting 506 an item comprises positioning (g) item K under first portion 104. Subsequently, replacing 508 first portion comprises reversing or releasing the pull back (d) of first portion 104. In instances, replacing 508 the first portion covers and retains the item (K) in the pocket 200. Furthermore, the replacing 510 the second portion comprises reversing pull back (c) of second portion 106. In instances, replacing 510 the second portion covers the first portion 104, thereby providing additional retention and security to the pocket 200. Without limitation, once the step of replacing 510 the second portion is completed, activity 512 may be resumed with the item retained. Alternatively, it may be understood by a person of ordinary skill the pocket 200 may be accessed as described here when the band with expandable pouch 100 is not being worn, for example while being hand held, without limitation.

An illustrative process for manufacturing the band with expandable pouch 100 is illustrated in FIG. 7. In various embodiments, the process 600 comprises the steps of obtaining 602 a material, forming 604 a first fold 604, forming 606 a second fold, fixing 608 the ends, and connecting 610 the ends to form the band with expandable pouch 100 comprising a band with expanding pouch. More specifically, as found hereinabove and in reference to FIGS. 1 and 2, obtaining 602 a material comprises obtaining any material suitable for wearing on a person or touching a person's skin for extended periods. Non-limiting examples, material comprises cotton, polyamides, polyesters, spandex (i.e. polyurethane/urea copolymer), other fabrics or combinations thereof. The material may comprise any decorative features, colors, patterns, treatments, or combinations thereof, without limitation. In non-limiting exemplary configurations, a band with expandable pouch may comprise a reflective band or alternatively, may be constructed of a reflective material such as SCOTCHLITE™.

In embodiments of the present disclosure, forming 604 first fold (see C in FIG. 1) further comprises forming first portion 104. Without limitation, forming first fold 604 comprises folding material (see (a) in FIG. 1) such that first portion 104 is approximately one-third of the width W. Forming 606 second fold (see D in FIG. 1) further comprises forming second portion 106. Without limitation, forming second fold 606 comprises folding material (see (b) in FIG. 1) such that first portion 104 is approximately one-third of the width W.

In various embodiments, the step of fixing 608 ends of the material is optional, as denoted by the dotted line in FIG. 8. After forming 602, 604, the first fold and the second fold, the material has three layers. In the step of fixing the ends, the layers may be attached, for example by adhesives, rivets, staples, or other means known to an ordinarily skilled artisan for fixing material. Further, the step of fixing 608 the ends of the material may be completed by the subsequent step connecting 610 the ends. Connecting 610 the ends comprises forming a circle out of the folded material. In embodiments of the present disclosure, connecting 610 the ends comprises forming a circle or substantially circular shape, such that the base portion (e.g. 102 in FIG. 1) is oriented towards the center of the circle. Further the step of connecting 610 the ends comprises joining the ends at a seam or forming a seam. Non-limiting exemplary means for joining material at a seam or forming a seam include sewing, riveting, gluing, adhering, or combinations thereof.

In alternative embodiments according to the disclosure, after connecting 610 ends, installing 612 a fastener may provide additional retention and security means. Installing 612 a fastener is optional and may be desired in high vibration applications of the present disclosure. Installing 612 a fastener comprises attaching a portion of the fastener to the second portion (e.g. 106 in FIG. 3, FIG. 4) and a portion of the fastener to the first portion (e.g. 104 in FIG. 3, FIG. 4), such that when closed the fastener reversibly holds first portion and second portion. Alternatively, installing 612 a fastener comprises attaching a portion of the fastener to the base portion (e.g. 102 in FIG. 3, FIG. 4) and a portion of the fastener to the first portion (e.g. 104 in FIG. 3, FIG. 4), such that when closed the fastener reversibly holds base portion and first portion. As may be understood by a person of ordinary skill a fastener may be positioned in appropriate locations on the band with expandable pouch (e.g. 100 in FIG. 3, FIG. 4) to retain pocket (e.g. 200 in FIG. 3, FIG. 4) in a closed position. As previous disclosed herein, non-limiting suitable fasteners include a snap, button, hook and loop fastener, or others known to an ordinarily skilled artisan.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of broader terms such as “comprises”, “includes”, and “having” should be understood to provide support for narrower terms such as “consisting of”, “consisting essentially of”, and “comprised substantially of”. Accordingly, the scope of protection is not limited by the description set out above but is defined by the claims that follow, that scope including all equivalents of the subject matter of the claims. Each and every claim is incorporated as further disclosure into the specification, and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

We claim:

1. A band with expandable pouch, comprising:
a material extending between a first end and a second end;
a first fold extending between the first end and the second end; and
a second fold extending between the first end and the second end,
wherein the first end and the second end are connected.

2. The article of claim 1, wherein the material is reflective.

3. The article of claim 1, wherein the first fold forms a first portion and the second fold forms a second portion.

4. The article of claim 3, wherein the material between the first portion and the second portion forms a base portion.

5. The article of claim 4, wherein the first portion folds over and at least partially covers the base portion.

6. The article of claim 3, wherein the second portion folds over and at least partially covers the first portion.

7. The article of claim 3, wherein the first fold and the second fold form a pocket therebetween.

8. A method for manufacturing a band with expandable pouch, comprising:
obtaining a wearable material;
forming a first portion in the material extending between a first end and a second end;
forming a second portion in the material extending between a first end and a second end; and
joining the first end and the second end to form a loop.

9. The method of claim 8, wherein forming a first portion comprises making a first fold in the material.

10. The method of claim 8, wherein forming a second portion comprises making a second fold in the material.

11. The method of claim 8, wherein forming a first portion and a second portion in the material further comprises forming a pocket.

12. A method for carrying an item, comprising:
forming a pocket in a material formed in a loop;
positioning the loop on a person; and
inserting the item into the pocket.

13. The method of claim 12, wherein forming a pocket comprises:
obtaining a material extending between a first end and a second end;
forming a first portion by folding the material between the first end and a second end;
forming a second portion by folding the material between the first end and a second end; and
connecting the first end.

14. The method of claim 12, wherein inserting the item further comprises
pulling back a first portion of the pocket to reveal a second portion;
positioning the item under the second portion; and
returning the first portion to the original position.

15. The method of claim 12 wherein the material is reflective.

16. A method for carrying an item in a band with expandable pouch, comprising:
obtaining a band with expandable pouch, having a substantially circular shape and a pocket, wherein the pocket is formed by a second portion overlying a first portion and a first portion overlying a base portion;
pulling the second portion, such that the first portion is exposed;
pulling the first portion, such that the base portion is exposed;
positioning an item near the base portion and at least partially behind the first portion, such that the item is at least partially disposed between the base portion and the first portion;
returning the first portion to an original position, such that the item is enclosed by the base portion and the first portion; and
returning the second portion to an original position, such that the second portion is substantially overlying the first portion.

17. A method for carrying an item, comprising:
forming a pocket in a material formed in a loop;
inserting the item into the pocket, and;
positioning the loop on a person.

18. The method of claim 17, wherein forming a pocket comprises:
obtaining a material extending between a first end and a second end;
forming a first portion by folding the material between the first end and a second end;
forming a second portion by folding the material between the first end and a second end; and
connecting the first end.

19. The method of claim 17, wherein inserting the item further comprises
pulling back a first portion of the pocket to reveal a second portion;
positioning the item under the second portion; and
returning the first portion to the original position.

20. The method of claim 17 wherein the material is reflective.
